(19) United States
(12) Patent Application Publication
(10) Pub. No.: US 2025/0236700 A1
(43) Pub. Date: Jul. 24, 2025

(54) POLYURETHANE COMPOSITIONS AND VISCOELASTIC POLYURETHANE FOAMS HAVING REDUCED SURFACE DEFECT PREPARED WITH SAME

(71) Applicant: Dow Global Technologies LLC, Midland, MI (US)

(72) Inventors: Luca Lotti, Rubiera (IT); Degang Zhang, Shanghai (CN)

(21) Appl. No.: 18/703,383

(22) PCT Filed: Nov. 25, 2021
(86) PCT No.: PCT/CN2021/133011

§ 371 Date: Apr. 22, 2024

(51) Int. Cl. C08G 18/48; C08G 18/08; C08G 18/12; C08G 18/18; C08G 101/00; C08J 9/06

(52) U.S. Cl. CPC C08G 18/4808; C08G 18/12; C08G 18/14; C08G 18/18; C08G 18/4816; C08G 18/485; C08J 9/06; C08G 2101/00; C08J 2203/10; C08J 2375/00

(57) ABSTRACT

A polyurethane composition, comprising (A) an isocyanate compound and (B) a polyol blend of three polyether polyols having particularly designed formulation and OH functionality, is provided. The viscoelastic polyurethane foam prepared by using said polyurethane composition exhibits tailored viscoelastic properties and superior aesthetic appearance.

### FIELD OF THE INVENTION

The present disclosure relates to a polyurethane (PU) composition and a polyurethane foam having reduced surface defects prepared by using the composition. The polyurethane composition comprises a blend of three polyether polyols particularly designed for substantially inhibiting the formation of defects at the surface of the resultant viscoelastic polyurethane foam, thus producing a viscoelastic polyurethane foam with tailored viscoelastic properties and superior aesthetic appearance.

### BACKGROUND TECHNOLOGY

Viscoelastic polyurethane (PU) foam is a generally known polyurethane material exhibiting modest resilience and slow recovery rate, and has been used in a variety of office, household and vehicular applications, such as pillows, wheelchair seats, mattresses, etc., for the functions of cushioning, energy absorbing, sound and vibration damping. Nevertheless, there are still a plurality of challenges to be overcome. For example, one of the severe problems is the existence of defects such as, among others, air bubbles, pinholes, wrinkles, rips and ruptures both at the outer surface and within the inner volume of the polyurethane foam, and all of these defects will introduce undesirable inhomogeneous local microstructures which may have negative impact on the vibration absorption efficiency of the polyurethane foam article. In many applications the viscoelastic polyurethane (PU) foam often has a modest thickness of up to several centimeters, and it is typically formed in a thin cavity mold. The growth and expansion of a reactive mixture composed of a polyol component including polyols and additives such as catalyst, surfactants and blowing agent, and an isocyanate component in such a thin cavity mold will generally encounter a non-laminar flow of all the reactants, and the turbulences caused by such a non-laminar flow is believed as one of the essential sources for the formation or entrapment of various defects in the final polyurethane foam. Intensive efforts have been made to solve this problem in the past, but the research results were still very limited. Therefore, there is a long-standing need to develop a unique technology which can be used for effectively inhibiting the formation and entrapment of defects during the production of the polyurethane foam while retaining the viscoelasticity of the resultant foam product.

After persistent exploration, we have surprisingly developed a composition comprising a unique blend of polyols which can achieve the above stated targets.

### SUMMARY OF THE INVENTION

The present disclosure provides a unique polyurethane composition, and a polyurethane foam product prepared by using the composition, wherein the composition comprises a blend of three particularly defined polyols which can inhibit the non-laminar flow during the preparation of a polyurethane foam and thus produce a foam product having tailored viscoelastic properties and superior aesthetic appearance.

In a first aspect of the present disclosure, the present disclosure provides a polyurethane composition for preparing a viscoelastic polyurethane foam, comprising
(A) at least one isocyanate compound comprising at least two isocyanate groups; and
(B) a polyol blend comprising
(b1) a first polyether polyol, which is a poly(C₂-C₆ alkylene oxide)-based polyol end-capped with ethylene oxide moieties, and has a OH functionality of 4 or larger,
(b2) a second polyether polyol, which is a poly(C₂-C₆ alkylene oxide)-based polyol end-capped with propylene oxide moieties, and has a OH functionality of 2 to 6, and
(b3) a third polyether polyol, which is a random copolymer of two or more (C₂-C₆)alkylene oxides, and has a OH functionality of 2 to 6.

In a second aspect of the present disclosure, the present disclosure provides a viscoelastic polyurethane foam product prepared by using the above indicated polyurethane composition.

It is to be understood that both the foregoing general description and the following detailed description are exemplary and explanatory only and are not restrictive of the invention, as claimed.

### BRIEF DESCRIPTION OF THE DRAWINGS

FIG. 1 is the photograph of a polyurethane foam prepared by an Inventive Example of the present disclosure;

FIG. 2 is the photograph of a polyurethane foam prepared by a Comparative Example of the present disclosure.

### DETAILED DESCRIPTION OF THE INVENTION

Unless defined otherwise, all technical and scientific terms used herein have the same meaning as commonly understood by one of ordinary skill in the art to which the invention belongs. Also, all publications, patent applications, patents, and other references mentioned herein are incorporated by reference.

As disclosed herein, “and/or” means “and, or as an alternative”. All ranges include endpoints unless otherwise indicated. Unless indicated otherwise, all the percentages and ratios are calculated based on weight, and all the molecular weights are weight average molecular weights (Mw) in g/mol.

Without being limited to any specific theory, the technical breakthrough of the present disclosure mainly resides in the particularly designed polyol blend which is used as the isocyanate-reactive compound in the composition. Especially speaking, the viscoelastic polyurethane foam is typically prepared by combining a polyol component including polyol(s) and additives such as catalyst, surfactants and blowing agent with an isocyanate component, allowing the reactant mixture to react and expand in a mold, such as a thin-cavity mold. It is estimated that the non-laminar flow and turbulence occurred during the reaction is an essential source for the formation or entrapment of various defects, such as air bubbles, in the final polyurethane foam. It is surprisingly found that the blend of particularly defined three polyols can effectively inhibit the entrapment of air bubbles and formation of defects in the final foam.

According to an embodiment of the present disclosure, the polyurethane composition of the present disclosure comprises a polyol blend comprising: (b1) a first polyether polyol which is a poly(C₂-C₆ alkylene oxide)-based polyol end-capped with ethylene oxide moieties and has a OH functionality of 4 or larger; (b2) a second polyether polyol which is a poly(C₂-C₆ alkylene oxide)-based polyol end-capped with propylene oxide moieties and has a OH functionality of 2 to 6; and (b3) a third polyether polyol which is a random copolymer of two or more (C₂-C₆)alkylene oxides and has a OH functionality of 2 to 6.

According to one embodiment of the present disclosure, the C₂-C₆ alkylene oxide of the first polyether polyol can be selected from the group consisting of ethylene oxide, propylene oxide, butylene oxide, pentylene oxide and hexylene oxide. According to an exemplary embodiment of the present disclosure, the C₂-C₆ alkylene oxide of the first polyether polyol can be propylene oxide, i.e. the first polyether polyol can be a poly(propylene oxide)-based polyol end-capped with ethylene oxide moieties. According to one separated embodiment of the present disclosure, the first polyether polyol has an ethylene oxide content of at least 14 wt %, or from 14 wt % to 45 wt %, or from 15 wt % to 40 wt %, based on the total weight of the first polyether polyol, such as within a numerical range obtained by combining any two of the following values: 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt % and 45 wt %. According to another embodiment of the present disclosure, the first polyether polyol has a hydroxyl functionality of at least 4.0, or from 4.0 to 10.0, or from 4.0 to 6.0, such as within a numerical range obtained by combining any two of the following values: 4.0, 4.2, 4.4, 4.5, 4.7, 4.8, 5.0, 5.2, 5.4, 5.5, 5.7, 5.8, 6.0, 6.2, 6.4, 6.5, 6.7, 6.8, 7.0, 7.2, 7.4, 7.5, 5.7, 7.8, 8.0, 8.2, 8.4, 8.5, 8.7, 8.8, 9.0, 9.2, 9.4, 9.5, 9.6, 9.7, 9.8 and 10.0. According to an embodiment of the present disclosure, the first polyether polyol has a molecular weight of 3,000 to 10,000, or from 4,000 to 9,000, or from 5,000 to 8,000, or from 6,000 to 7,000, such as within a numerical range obtained by combining any two of the following values: 3,000, 3,200, 3,500, 3,800, 4,000, 4,200, 4,500, 4,800, 5,000, 5,200, 5,500, 5,800, 6,000, 6,200, 6,500, 6,800, 7,000, 7,200, 7,500, 7,800, 8,000, 8,200, 8,500, 8,800, 9,000, 9,200, 9,500, 9,800 and 10,000.

According to another embodiment of the present disclosure, when the total weight of the polyol blend is taken as 100 parts per hundred of polyol (pphp), the content of the first polyether polyol is from 50 to 75 pphp, such as from 51 to 72 pphp, or within a numerical range obtained by combining any two of the following values: 50 pphp, 51 pphp, 51.8 pphp, 52 pphp, 53 pphp, 54 pphp, 55 pphp, 56 pphp, 57 pphp, 58 pphp, 59 pphp, 60 pphp, 60.4 pphp, 61 pphp, 62 pphp, 62.5 pphp, 63 pphp, 64 pphp, 65 pphp, 66 pphp, 67 pphp, 68 pphp, 69 pphp, 70 pphp, 71 pphp, 71.1 pphp, 72 pphp, 73 pphp, 73.1 pphp, 74 pphp and 75 pphp.

Examples of the first polyether polyol may be commercially purchased from suppliers, such as SPECFLEX™ NC 632 and SPECFLEX™ NC 630 available from the Dow Chemical Company.

According to one embodiment of the present disclosure, the C₂-C₆ alkylene oxide of the second polyether polyol can be selected from the group consisting of ethylene oxide, propylene oxide, butylene oxide, pentylene oxide and hexylene oxide. The second polyether polyol can be considered as a homopolymerized polypropylene oxide-based polyol or full-polypropylene oxide-based polyol when the C₂-C₆ alkylene oxide of the second polyether polyol is propylene oxide. According to a separated embodiment of the present disclosure, the C₂-C₆ alkylene oxide of the second polyether polyol is C₃-C₆ alkylene oxide. According to an exemplary embodiment of the present disclosure, the C₂-C₆ alkylene oxide of the second polyether polyol can be propylene oxide, i.e. the second polyether polyol is a poly(propylene oxide)-based polyol end-capped with propylene oxide moieties, which can also be considered as a homopolymerized or full polypropylene oxide-based polyol. According to one separated embodiment of the present disclosure, the second polyether polyol has a propylene oxide content of up to 100 wt %, or from 5 wt % to 100 wt %, based on the total weight of the second polyether polyol, such as within a numerical range obtained by combining any two of the following values: 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt %, 24 wt %, 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt %, 45 wt %, 46 wt %, 47 wt %, 48 wt %, 49 wt %, 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt %, 90 wt %, 91 wt %, 92 wt %, 93 wt %, 94 wt %, 95 wt %, 96 wt %, 97 wt %, 98 wt %, 99 wt % and 100 wt %. According to another embodiment of the present disclosure, the second polyether polyol has a hydroxyl functionality of 2.0 to 6.0, or from 2.0 to 5.0, or from 2.0 to 4.0, or from 2.0 to 3.5, or from 2.5 to 3.2, or from 2.8 to 3.0, such as within a numerical range obtained by combining any two of the following values: 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9 and 6.0. According to a specific embodiment of the present disclosure, the second polyether polyol is a poly(propylene oxide)-based polyol end-capped with propylene oxide moieties, i.e. a homopolymerized or full polypropylene oxide-based polyol, and has a OH functionality of 2 to 6, such as 3. According to an embodiment of the present disclosure, the second polyether polyol has a molecular weight of 150 to 2,500, or from 500 to 2,000, or from 700 to 1,000, such as within a numerical range obtained by combining any two of the following values: 150, 200, 250, 300, 350, 400, 450, 500, 550, 600, 650, 700, 750, 800, 850, 900, 950, 1,000, 1,050, 1,100, 1,150, 1,200, 1,250, 1,300, 1,350, 1,400, 1,450, 1,500, 1,550, 1,600, 1,650, 1,700, 1,750, 1,800, 1,850, 1,900, 1,950, 2,000, 2,050, 2,100, 2,150, 2,200, 2,250, 2,300, 2,350, 2,400, 2,450 and 2,500.

According to another embodiment of the present disclosure, when the total weight of the polyol blend is taken as 100 parts per hundred of polyol (pphp), the content of the second polyether polyol is from 20 to 35 pphp, such as from 21 to 33 pphp, or within a numerical range obtained by combining any two of the following values: 20 pphp, 21 pphp, 21.4 pphp, 22 pphp, 23 pphp, 24 pphp, 25 pphp, 26 pphp, 27 pphp, 28 pphp, 29 pphp, 30 pphp, 31 pphp, 32 pphp, 32.1 pphp, 33 pphp, 34 pphp and 35 pphp.

Examples of the second polyether polyol may be commercially purchased from suppliers, such as VORANOL™ 270, VORANOL™ 2070, VORANOL™ CP 755, VORANOL™ 450 and VORANOL™ CP 1055 available from the Dow Chemical Company.

According to one embodiment of the present disclosure, the third polyether polyol can be a random copolymer of ethylene oxide and propylene oxide, a random copolymer of ethylene oxide and butylene oxide, a random copolymer of propylene oxide and butylene oxide, or a random copolymer of ethylene oxide, propylene oxide and butylene oxide. According to another embodiment of the present disclosure, the third polyether polyol is a ethylene oxide-propylene oxide random copolymer having an ethylene oxide content of from 55 wt % to 90 wt %, or from 58 wt % to 85 wt %, or from 60 wt % to 80 wt %, or from 65 wt % to 76 wt %, or from 68 wt % to 75 wt %, or from 70 wt % to 72 wt %, based on the total weight of the third polyether polyol, such as within a numerical range obtained by combining any two of the following values: 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt %, 72 wt %, 73 wt %, 74 wt %, 75 wt %, 76 wt %, 77 wt %, 78 wt %, 79 wt %, 80 wt %, 81 wt %, 82 wt %, 83 wt %, 84 wt %, 85 wt %, 86 wt %, 87 wt %, 88 wt %, 89 wt % and 90 wt %, with the balance content being propylene oxide.

According to another embodiment of the present disclosure, the third polyether polyol has a hydroxyl functionality of 2.0 to 6.0, or from 2.0 to 5.5, or from 2.0 to 5.0, or from 2.0 to 4.5, or from 2.0 to 4.0, or from 2.0 to 3.5, or from 2.5 to 3.2, or from 2.8 to 3.0, such as within a numerical range obtained by combining any two of the following values: 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9 and 6.0. According to an embodiment of the present disclosure, the third polyether polyol has a Molecular weight of 1,550 to 10,000, or from 2,000 to 9,000, or from 3,000 to 8,000, or from 4,000 to 7,000, from 5,000 to 6,000, such as within a numerical range obtained by combining any two of the following values: 1,550, 1,600, 1,700, 1,800, 2,000, 2,200, 2,500, 2,800, 3,000, 3,200, 3,500, 3,800, 4,000, 4,200, 4,500, 4,800, 5,000, 5,200, 5,500, 5,800, 6,000, 6,200, 6,500, 6,800, 7,000, 7,200, 7,500, 7,800, 8,000, 8,200, 8,500, 8,800, 9,000, 9,200, 9,500, 9,800 and 10,000.

According to another embodiment of the present disclosure, when the total weight of the polyol blend is taken as 100 parts per hundred of polyol (pphp), the content of the third polyether polyol is from 5 to 20 pphp, or from 7 to 18 pphp, or from 10 to 15 pphp, such as within a numerical range obtained by combining any two of the following values: 5 pphp, 6 pphp, 7 pphp, 8 pphp, 9 pphp, 10 pphp, 11 pphp, 12 pphp, 13 pphp, 14 pphp, 15 pphp, 16 pphp, 17 pphp, 18 pphp, 19 pphp and 20 pphp.

Examples of the third polyether polyol may be commercially purchased from suppliers, such as Dow VORANOL™ 1447 and VORANOL™ CP 1421 available from the Dow Chemical Company.

The content of the polyol blend, i.e. the combined content of the first, second and third polyether polyols, may vary based on the actual requirement of the viscoelastic polyurethane foam. For example, as one illustrative embodiment, the content of the polyol blend can be from 50 wt % to 80 wt %, or from 52 wt % to 70 wt %, or from 55 wt % to 65 wt %, or from 58 wt % to 60 wt %, based on the total weight of the polyurethane composition, such as within a numerical range obtained by combining any two of the following values: 50 wt %, 51 wt %, 52 wt %, 53 wt %, 54 wt %, 55 wt %, 56 wt %, 57 wt %, 58 wt %, 59 wt %, 60 wt %, 61 wt %, 62 wt %, 63 wt %, 64 wt %, 65 wt %, 66 wt %, 67 wt %, 68 wt %, 69 wt %, 70 wt %, 71 wt % 72 wt %, 73 wt %, 74 wt %, 75 wt %, 76 wt %, 77 wt %, 78 wt %, 79 wt % and 80 wt %.

According to one embodiment of the present disclosure, the polyurethane composition of the present disclosure does not comprise additional isocyanate-reactive compound other than the first to third polyether polyols. As used herein, the term “additional isocyanate-reactive compound” refers to a compound with the sole function of reacting with the isocyanate and forming the polyurethane main chain, thus this term does not include the additives generally used for different functions during the manufacture of the polyurethane foam, e.g. chain extender, crosslinker, silicone surfactant, blowing agent or catalysts.

According to a separate embodiment of the present disclosure, one or more additional isocyanate-reactive compound(s) other than the first to third polyether polyols can be used in combination with the polyol blend of the first to third polyether polyols, wherein the weight ratio between the additional isocyanate-reactive compound and the polyol blend of the first to third polyether polyols can be from 0.1:100 to 50:100, or from 0.5:100 to 45:100, or from 1:100 to 40:100, or from 2:100 to 35:100, or from 3:100 to 30:100, or from 4:100 to 25:100, or from 5:100 to 20:100, or from 6:100 to 15:100, or from 7:100 to 12:100, or from 8:100 to 10:100. When present, the additional isocyanate-reactive compound can be selected from the group consisting of C₂-C₁₆ aliphatic polyhydric alcohol comprising at least two hydroxyl groups, C₆-C₁₆ cycloaliphatic polyhydric alcohol comprising at least two hydroxyl groups, C₆-C₁₆ aromatic polyhydric alcohol comprising at least two hydroxyl groups, C₇-C₁₅ araliphatic polyhydric alcohol comprising at least two hydroxyl groups, polyester polyol having a molecular weight from 500 to 12,000, polycarbonate polyol having a molecular weight from 200 to 8,000, polyether polyol which is different from the first to third polyether polyols and has a molecular weight from 200 to 8,000, core-shell polymer polyol having a core phase and a shell phase based on polyol, or any combinations thereof. The shell phase of the core-shell polymer polyol may comprise any one or more of the above stated additional isocyanate-reactive compound(s). The core phase of the core-shell polymer polyol may be micro-sized and may comprise any polymers compatible with the shell phase. For example, the core phase may comprise polystyrene, polyacrylonitrile, polyester, polyolefin or polyether.

In various embodiments, the isocyanate compound comprising at least two isocyanate groups is also known as polyisocyanate compound and refers to an aliphatic, cycloaliphatic, aromatic, araliphatic or heteroaryl compound having at least two isocyanate groups. The isocyanate compound may have an average functionality of at least about 2.0, such as from about 2 to 10, or from about 2 to about 8, or from about 2 to about 6, or from about 2 to about 5, or from about 2 to about 4, or from about 2 to about 3. Exemplary isocyanate compound can be selected from the group consisting of C₂-C₁₂ aliphatic isocyanate compound comprising at least two isocyanate groups, C₆-C₁₅ cycloaliphatic isocyanate compound comprising at least two isocyanate groups, C₆-C₁₅ aromatic isocyanate compound comprising at least two isocyanate groups, C₇-C₁₅ araliphatic isocyanate compound comprising at least two isocyanate groups, and any combinations thereof. In another embodiment, the isocyanate compounds may particularly include m-phenylene diisocyanate, 2,4-toluene diisocyanate, 2,6-toluene diisocyanate (TDI), various isomers of diphenylmethanediisocyanate (MDI), methylenebis(cyclohexyl isocyanate) (HMDI), hexamethylene-1,6-diisocyanate (HDI), tetramethylene-1,4-diisocyanate, cyclohexane-1,4-diisocyanate, hexahydrotoluene diisocyanate, hydrogenated MDI, naphthylene-1,5-diisocyanate, isophorone diisocyanate (IPDI), or mixtures thereof. Examples of the above said isocyanate compound may be commercially purchased from suppliers, such as SPECFLEX™ NE138, ISONATE™ M125 and ISONATE™ OP50 available from the Dow Chemical Company. According to another embodiment of the present disclosure, the isocyanate compound can be modified isocyanate compounds, that is, products which are obtained through chemical modification of the above isocyanate compounds. Exemplary modified isocyanate compounds are polyisocyanates containing esters, ureas, biurets, isocyanurates, allophanates, carbodiimides or uretonimines, such as 4,4′-carbodiimide modified MDI products. For example, liquid isocyanate compounds containing carbodiimide groups, uretonimines groups or isocyanurate rings and having isocyanate group (NCO) contents of from 10 to 40 weight percent, such as from 20 to 35 weight percent, can be used. An additional example may also include a mixture of at least one of the above said the isocyanate compound with other ingredients, such as polymeric MDI, which is known as a mixture of about 50 wt % MDI and the balance amount of higher molecular weight polycyclic species and can be commercially purchased from suppliers, e.g. PAPI 27 available from the Dow Chemical Company.

Alternatively or additionally, the isocyanate compound may comprise an isocyanate prepolymer with a NCO functionality in the range of 2 to 10, such as from 2 to 8, or from 2 to 6, or from 2 to 5, or from 2 to 4. The isocyanate prepolymer can be obtained by reacting one or more of the above stated monomeric isocyanate compound(s) with one or more isocyanate-reactive compounds selected from the group consisting of C₂-C₁₆ aliphatic polyhydric alcohol comprising at least two hydroxy groups, C₅-C₁₆ cycloaliphatic polyhydric alcohol comprising at least two hydroxy groups, C₆-C₁₆ aromatic polyhydric alcohol comprising at least two hydroxy groups, C₇-C₁₅ araliphatic polyhydric alcohol comprising at least two hydroxy groups, polyester polyol having a molecular weight from 500 to 5,000, polycarbonate polyol having a molecular weight from 200 to 5,000, polyether polyol having a molecular weight from 200 to 8,000, or any combinations thereof, with the proviso that the isocyanate prepolymer comprises at least two free isocyanate groups, i.e. the raw materials relative amount for preparing the prepolymer is in excess of isocyanate so that the final prepolymer remains with free isocyanate moieties. The polyether polyol can be identical with or different from any one of the above stated first to third polyether polyols. For example, the isocyanate-reactive compound for preparing said isocyanate prepolymer can be selected from the group consisting of ethylene glycol, 1,2-propanediol, 1,3-propanediol, 1,3-butanediol, 1,4-butanediol, 1,4-butenediol, 1,4-butynediol, 1,5-pentanediol, neopentyl-glycol, bis(hydroxy-methyl) cyclohexanes such as 1,4-bis(hydroxy methyl)cyclohexane, 2-methylpropane-1,3-diol, methylpentanediols, diethylene glycol, triethylene glycol, tetraethylene glycol, polyethylene glycol, dipropylene glycol, polypropylene glycol, dibutylene glycol, polybutylene glycols, bishydroxyethyl-bisphenol A, bishydroxypropyl-bisphenol A, cyclohexane dimethanol, and bishydroxyethyl hydroquinone. An example of the polyol for preparing the isocyanate prepolymer is VORANOL™ CP 6001 available from the Dow Chemical Company. Suitable isocyanate prepolymers may have a NCO group content of from 2 to 40 weight percent, such as from 4 to 30 weight percent. Examples of the above said isocyanate prepolymer may be commercially purchased from suppliers, such as SPECFLEX™ NE 135 available from the Dow Chemical Company.

The content of the isocyanate compound may vary based on the actual requirement of the viscoelastic polyurethane foam. As one illustrative embodiment, the content of the isocyanate compound can be from 25 wt % to 45 wt %, or from 30 wt % to 40 wt %, or from 32 wt % to 35 wt %, based on the total weight of the polyurethane composition, such as within a numerical range obtained by combining any two of the following values: 25 wt %, 26 wt %, 27 wt %, 28 wt %, 29 wt %, 30 wt %, 31 wt %, 32 wt %, 33 wt %, 34 wt %, 35 wt %, 36 wt %, 37 wt %, 38 wt %, 39 wt %, 40 wt %, 41 wt %, 42 wt %, 43 wt %, 44 wt % and 45 wt %. According to an embodiment of the present disclosure, the amount of the isocyanate compound is properly selected so that the isocyanate group is present at a stoichiometrically equivalent amount or a stoichiometrically defective amount relative to the total molar amount of the isocyanate-reactive groups (e.g. hydroxyl groups, amino groups, etc.) included in the polyol compound and all the other ingredients such as chain extender, crosslinker, modifier, compatibilizer, solvent and cosolvent. For example, the molar ratio between the isocyanate group and the isocyanate-reactive group can be from 0.6:1 to 1:1, or from 0.7:1 to 1:1, or from 0.8:1 to 1:1, or from 0.9:1 to 1:1, such as about 1:1.

In various embodiments of the present disclosure, the polyurethane composition comprises one or more additives selected from the group consisting of catalyst, surfactant, chain extender, crosslinker, blowing agent, foaming agent, frothing agent, foam stabilizer, antioxidant, tackifier, plasticizer, rheology modifier, UV-absorber, light-stabilizer, cocatalyst, filler, colorant, pigment, solvent, diluent, flame retardant, slippery-resistance agent, antistatic agent, preservative, biocide and any combinations thereof. These additives can be transmitted and stored as independent components and incorporated into the polyurethane composition shortly or immediately before the combination of the isocyanate compound with the polyol blend and any other isocyanate-reactive compound(s), if any. Alternatively, these additives may be contained in either of the isocyanate compound and the polyol blend when they are chemically inert or substantially inert to the isocyanate group or the isocyanate-reactive group.

Suitable surfactants are materials that stabilize the foam formed during the foaming reaction until the foam has sufficiently cured to be self-supportable. A wide variety of silicone surfactants commonly used in making polyurethane foams can be used in the present disclosure. Examples of such silicone surfactants are commercially available, such as VORASURF™ DC 2525 from the Dow Chemical Company and Tegostab B8734 LF2 from Evonik Industries AG.

Surfactant is typically present at an extra content of up to 5 pphp, such as from 0.1 to 4 pphp, or from 0.2 to 3 pphp, or from 0.3 to 2 pphp, or from 0.4 to 1 pphp, or from 0.5 to 0.8 pphp, with the total weight of the polyol blend being taken as 100 pphp.

As used herein, the term “extra content” means that the content of the related subject does not constitute a part of the polyol blend total weight. For example, the combination of 100 pphp polyol blend with 0.5 pphp extra content of a surfactant or any other components will result in a combined weight of 100.5 pphp.

One or more crosslinkers also may be present in the polyurethane composition of the present disclosure. For purposes of this invention, “crosslinkers” are materials having three or more isocyanate-reactive groups per molecule and an equivalent weight per isocyanate-reactive group of less than 300, such as less than 200. Crosslinkers usually contain from 3 to 8, especially from 3 to 4 hydroxyl (including primary hydroxyl, secondary hydroxyl and tertiary hydroxyl), primary amine, secondary amine, or tertiary amine groups per molecule and have an equivalent weight of from 30 to about 200, especially from 50 to 125. According to an embodiment of the present disclosure, the crosslinker can be selected from the group consisting of diethanol amine (DEOA), triethanol amine (TEOA), di-(isopropanol) amine, tri(isopropanol) amine, glycerine, trimethylol propane, pentaerythritol, and any combinations thereof, such as a combination of DEOA and TEOA. The crosslinker can be present as a mixture with the polyol blend.

The chain extender is a chemical substance having two or more isocyanate-reactive groups per molecule and an equivalent weight per isocyanate-reactive group of less than 300, such as less than 200. The isocyanate reactive groups can be hydroxyl, primary aliphatic or aromatic amino or secondary aliphatic or aromatic amino groups. Representative chain extenders include monoethylene glycol (MEG), diethylene glycol, triethylene glycol, propylene glycol, dipropylene glycol, tripropylene glycol, 1,4-butanediol, cyclohexane dimethanol, ethylene diamine, phenylene diamine, bis(3-chloro-4-aminophenyl) methane, dimethylthio-toluenediamine or diethyltoluenediamine. According to an embodiment of the present disclosure, the chain extender is a short chain (such as C₂ to C₄) polyol exclusively comprising hydroxyl group as the isocyanate-reactive group, such as monoethylene glycol. According to another embodiment of the present disclosure, the chain extender can be selected from the group consisting of ethylene glycol, propane diol, butane diol, pentane diol, hexane diol, 1,4-cyclohexane dimethanol, and their isomers. The chain extender can be present as a mixture with the polyol blend.

Chain extenders and crosslinkers are suitably used in small amounts, as the hardness of the final foam increases as the amount of either of these materials increases. The chain extender is typically present at an extra content of up to 5 pphp, such as from 0.1 to 4 pphp, or from 0.2 to 3 pphp, or from 0.3 to 2 pphp, or from 0.4 to 1.5 pphp, or from 0.5 to 1.0 pphp, or from 0.6 to 0.8 pphp, with the total weight of the polyol blend being taken as 100 pphp. The crosslinker can be present at an extra content of up to 5 pphp, such as from 0.1 to 4 pphp, or from 0.2 to 3 pphp, or from 0.3 to 2 pphp, or from 0.4 to 1.5 pphp, or from 0.5 to 1.0 pphp, or from 0.6 to 0.8 pphp, with the total weight of the polyol blend being taken as 100 pphp.

The blowing agent may be a chemical (exothermic) type, a physical (endothermic) type or a mixture of at least one of each type. Chemical blowing agents are typically substances that react or decompose to produce carbon dioxide or carbon monoxide gases under the conditions of the foaming reaction. Water and formic acid are examples of suitable chemical blowing agents. Physical blowing agent includes carbon dioxide, various low-boiling hydrocarbons, hydrofluorocarbons, hydrofluorochlorocarbons, ethers and the like. Water is one of the typical chemical blowing agents, either by itself or in combination with one or more chemical or physical blowing agents. The blowing agent can be present at an extra content of up to 10 pphp, such as from 0.5 to 8 pphp, or from 0.8 to 7 pphp, or from 1 to 6 pphp, or from 2 to 5 pphp, or from 3 to 4 pphp, with the total weight of the polyol blend being taken as 100 pphp.

Any catalysts that effectively promote the reaction between the isocyanate group and the isocyanate-reactive group can be used in the present application. For example, the catalyst can be selected from the group consisting of amine-based catalyst, such as ethylene diamine, propylene diamine, butylene diamine, pentylene diamine, neopentylenediamine, hexylene diamine, heptylene diamine, neoheptylene diamine, N,N-dimethylcyclohexylamine, N,N-bis(3-(di-methylamino) propyl)-N-diisopropanolamine, bis(2-dimethylaminoethyl) ether, methyltriethylenediamine, dimethylaminopropylamine, bis(N,N-dimethyl-3-amino-propyl)amine, bis(2-dimethylamino ethyl)ether, 1,1′-((3-(di-methylamino)propyl)azanediyl) bis(propan-2-ol), 2,4,6-tridimethyl amino-methyl)phenol, N,N,N′,N′-tetra-methyl-ethylenediamine, N,N,N′,N′-tetramethyl-propylenediamine, N,N,N′,N′-tetramethyl-butylenediamine, N,N,N′,N′-tetramethyl-pentylene diamine, N,N,N′,N′-tetramethyl-hexylene diamine, N,N-dimethyl benzylamine, triethylene diamine, pentamethyldiethylenetriamine, diethylenetriamine, N-methylmorpholine, N-ethyl morpholine, 2-methylpropanediamine, N,N′-diethylpiperazine, N,N′-dimethyl piperazine, pyridine, N,N′-dimethyl pyridine, quinoline, N,N′,N″-tris(dimethyl amino-propyl)sym-hexahydro triazine; glycine salts; tertiary phosphines, such as trialkylphosphines and dialkylbenzylphosphines; chelates of various metals, such as those which can be obtained from acetylacetone, benzoylacetone, trifluoroacetyl acetone, ethyl acetoacetate and the like with metals such as Be, Mg, Zn, Cd, Pd, Ti, Zr, Sn, As, Bi, Cr, Mo, Mn, Fe, Co and Ni; acidic metal salts of strong acids such as ferric chloride and stannic chloride; salts of organic acids with variety of metals, such as alkali metals, alkaline earth metals, Al, Sn, Pb, Mn, Co, Ni and Cu; organotin compounds, such as tin (II) salts of organic carboxylic acids, e.g., tin (II) diacetate, tin (II) dioctanoate, tin (II) diethylhexanoate, and tin (II) dilaurate, and dialkyltin (IV) salts of organic carboxylic acids, e.g., dibutyltin diacetate, dibutyltin dilaurate, dibutyltin maleate and dioctyltin diacetate; bismuth salts of organic carboxylic acids, e.g., bismuth octanoate; organometallic derivatives of trivalent and pentavalent As, Sb and Bi and metal carbonyls of iron and cobalt. Examples of such catalysts are commercially available as JEFFCAT catalysts, such as JEFFCAT ZR-50 from Huntsman Corporation. The catalyst can be present at an extra content of up to 8 pphp, such as from 0.5 to 7 pphp, or from 0.8 to 6 pphp, or from 1 to 5 pphp, or from 2 to 4 pphp, or from 2.1 to 3 pphp, with the total weight of the polyol blend being taken as 100 pphp.

The process for preparing the polyurethane foam may further comprise the use of additional additives such as demolding agent, foam stabilizer, tackifier, plasticizer, rheology modifier, UV-absorbent, light-stabilizer, cocatalyst, filler, colorant, pigment, solvent, diluent, flame retardant, slippery-resistance agent, antistatic agent, preservative, biocide or any combinations thereof.

For example, a demolding agent can be applied onto the surface of the mold before the casting step for the easy demolding of cured foam article. The demolding agent can be applied by being sprayed/poured onto the surface of the mold, followed by being dispersed with a cloth. Examples include commercially available demolding agents generally used in the relevant field, such as paraffin waxes dispersed in low molecular weight hydrocarbons, and a specific example is ChemTrend PU 1705 M from ChemTrend.

The viscoelastic polyurethane foam of the present disclosure can be prepared by using ordinary technologies such as cast molding, injection molding, pressure molding, die molding, free rise box foaming, spin cast molding and spray foaming, and can be manufactured and processed manually or automatically in a batchwise or continuous way. A typical process for preparing the viscoelastic polyurethane foam comprises the steps of (i) mixing the isocyanate compound with the polyol blend to form a reactive mixture, and (ii) casting the reactive mixture into a mold. According to an embodiment of the present disclosure, one or more substrate layers can be arranged in the mold beforehand, such as being arranged at the bottom of the mold, so as to be adhered to the polyurethane foam during the formation, foaming (foam-rising) and curing thereof, thus producing an integrated laminate structure comprising a viscoelastic polyurethane foam layer supported on the substrate layer. Examples of the substrate include metal substrate such as steel sheet, aluminum sheet, copper sheet, and any lamination or alloy thereof; polymer substrate such as EPDM layer, PTFE layer, PE layer and PP layer; and mineral substrate such as bitumen heavy layer.

According to any embodiment of the present disclosure, the mold used for preparing the polyurethane foam can be a thin-cavity mold. As used herein, the term “thin-cavity mold” refers to a mold having a shallow cavity. In particular, the thin/shallow cavity may have a longest dimension: shortest dimension ratio (e.g. the length/thickness ratio for a rectangular cavity) of at least 5:1, such as from 5:1 to 50:1, or from 8:1 to 40:1, or from 10:1 to 20:1, or from 12:1 to 18:1, and a longest dimension: second longest dimension ratio (e.g. the length/width ratio for a rectangular cavity) of about 4:1 to 1:1, such as from 3:1 to 1:1, or from 2:1 to 1:1, or from 1.5:1 to 1:1. Without being limited to any specific theory, it is extremely difficult to prepare a defect-free polyurethane foam, especially a defect-free viscoelastic polyurethane foam, in such a thin-cavity mold.

The slabstock or sheet of the resultant foam can be sliced and trimmed to desired dimension according to the requirements of the specific applications. The processing apparatus and processing parameters for the slabstock production and molding method are generally known in the relevant field. For example, the various ingredients may be introduced individually or in various subcombinations into a mixhead or other mixing device where they are mixed and dispensed into a region (such as a trough or other open container, or a closed mold) where they are cured. It is often convenient, especially when making molded foam, to form a formulated polyol component that contains the polyols, the amine-based catalyst system, crosslinkers, chain extenders (if any), and any other additives such as surfactant(s), blowing agent(s), and any combinations thereof. Then this formulated polyol component contacts with the isocyanate compound (as well as any other ingredients that are not present in the formulated polyol component) to produce the foam.

Some or all of the various ingredients or components may be heated prior to mixing them to form the reaction mixture. In other cases, the ingredients or components are mixed at approximately ambient temperatures (such as from 15 to 40° C.). Heat may be applied to the reaction mixture after all ingredients have been mixed, but this is often unnecessary. Suitable conditions for promoting the curing of the polyurethane polymer include a temperature of from about 20° C. to about 150° C., or from about 30° C. to about 120° C., or from about 35° C. to about 110° C., or from about 40° C. to about 50° C. In various embodiments, the temperature for curing may be selected at least in part based on the time duration required for the polyurethane polymer to cure at that temperature. Cure time will also depend on other factors, including, for example, the particular components (e.g., catalysts and quantities thereof), and the size and shape of the article being manufactured.

According to an embodiment of the present disclosure, the polyurethane foam product formed by the curing reaction may have a density of 5 to 200 kg/m³, such as from 8 to 180 kg/m³, or from 10 to 160 kg/m³, or from 12 to 150 kg/m³, or from 15 to 140 kg/m³, or from 18 to 120 kg/m³, or from 20 to 100 kg/m³, or from 24 to 80 kg/m³, or from 30 to 60 kg/m³, or from 40 to 50 kg/m³, or within a numerical range obtained by combining any two of the above stated end point values.

The description hereinabove is intended to be general and is not intended to be inclusive of all possible embodiments of the invention. Similarly, the examples hereinbelow are provided to be illustrative only and are not intended to define or limit the invention in any way. Those skilled in the art will be fully aware that other embodiments, within the scope of the claims, will be apparent from consideration of the specification and practice of the invention as disclosed herein. Such other embodiments may include selections of specific components and constituents and proportions thereof; mixing and reaction conditions, vessels, deployment apparatuses, and protocols; performance and selectivity; identification of products and by-products; subsequent processing and use thereof; and the like; and that those skilled in the art will recognize that such may be varied within the scope of the claims appended hereto. Besides, any embodiments obtainable by combining any two or more of the embodiments particularly illustrated above, or by combining any two or more of the technical features particularly illustrated above are also within the concept of the present disclosure.

### Examples

Some embodiments of the invention will now be described in the following Examples. However, the scope of the present disclosure is not, of course, limited to the formulations set forth in these examples. Rather, the Examples are merely inventive of the disclosure.

The information of the raw materials used in the examples is listed in the following table 1:

TABLE 1
Raw materials used in the examples

| Components | Grades | Detailed Information | Suppliers |
|---|---|---|---|
| Polyol 1 | SPECFLEX ™ NC632 | EO-capped poly(PO)-based polyether polyol | The Dow Chemical |
| | | having a hydroxy functionality ≥4 | Company |
| Polyol 2 | VORANOL ™ 270 | Full-PO-based polyether polyol having a | The Dow Chemical |
| | | hydroxy functionality of 3 | Company |
| Polyol 3 | VORANOL ™ 1447 | EO-PO random copolymer based polyether | The Dow Chemical |
| | | polyol having a hydroxy functionality of 3 and | Company |
| | | an EO content of 70 wt %. | |
| Polyol 4 | SPECFLEX ™ NC138 | EO-capped poly(PO)-based polyether polyol | The Dow Chemical |
| | | having a hydroxy functionality of 3 | Company |
| Demolding | ChemTrend PU | Paraffin waxes dispersed in low molecular | ChemTrend |
| agent | 1705M | weight hydrocarbons | |
| Crosslinker | DEOA | Diethanolamine | The Dow Chemical |
| | | | Company |
| Crosslinker | TEOA | Triethanolamine | The Dow Chemical |
| | | | Company |
| Surfactant | Tegostab B8734 LF2 | Silicone type surfactant | Evonik Industries AG |
| Catalyst | JEFFCAT ZR-50 | Amine catalyst | Huntsman |
| | | | Corporation |
| Isocyanate 1 | ISONATE M125 | Pure 4,4′-MDI | The Dow Chemical |
| | | | Company |
| Isocyanate 2 | ISONATE OP 50 | mixture of 4,4′-MDI and 2,4′-MDI | The Dow Chemical |
| | | | Company |
| Isocyanate 3 | PAPI 27 | Polymeric MDI | The Dow Chemical |
| | | | Company |
| H₂O | DI water | Deionized water | — |

### Part A. General Preparation Procedure of the Polyurethane Foam.

In the Inventive Examples 1 to 4 and Comparative Examples 1 to 11, polyurethane foams were prepared by the following steps: polyols, crosslinkers, surfactant, catalyst and DI water as shown in Table 2 and Table 3 were mixed to obtain a polyol component; the Isocyanate 1, Isocyanate 2 and Isocyanate 3 were mixed at a ratio of “Isocyanate 1:Isocyanate 2:Isocyanate 3=30:40:30” to obtain an isocyanate mixture which was used as the “Isocyanate” shown in Table 2 and Table 3; a little amount of demolding agent was sprayed onto the inner surface of a ˜500×1200×25 mm thin open mold with a certain non-regular shape including a circular insert reducing, locally, the thickness to 10 mm, and dispersed with a wiping cloth; the polyol component and the isocyanate were combined to form a reactive mixture which was immediately casted into the mold; the foaming and curing of the reactive mixture occurred within the mold for a period of 120 seconds, during which the mold was kept at a temperature of around 45° C.; and then the cured polyurethane foam was demolded and removed for characterization.

### Part B. Characterization Technology

The vibration damping performance of the foam was qualified with the parameter of damping factor according to DIN 53426, and the experimental results were summarized in the following Table 2 and Table 3. A damping factor higher than 0.25 is desirable since a foam having a lower damping factor will display a strong resonance peak (amplification phenomenon) at a certain resonance frequency, in particular during the use of the final foam as an article for noise and vibration damping.

The number of voids having a diameter of 1 cm or larger at one surface having the area of the previously cited mold was counted and used for scoring the aesthetics degree according the following criteria, and the experimental results were summarized in the following Table 2 and Table 3.

| Aesthetics score | Voids amount |
|---|---|
| 5 (best) | 0-5 |
| 4 | 5-10 |
| 3 | 10-15 |
| 2 | 15-20 |
| 1 (worst) | >20 |

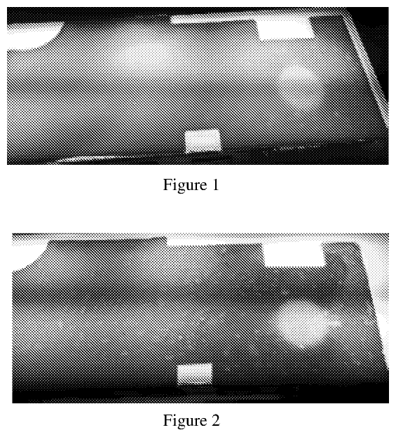

The polyurethane foam of the Inventive Example 1, which has a superior aesthetics score of 5, and the polyurethane foam prepared by the Comparative Example 5, which has an inferior aesthetics score of 1, were shown in FIG. 1 and FIG. 2, respectively. The non-regular shape of the mold is highlighted, with the round slim section (10 mm in thickness, while the rest of the mold is 25 mm) in evidence on the right-hand side. The comparison between FIG. 1 and FIG. 2 clearly shows the improvement in the aesthetics performance of the Inventive Example. Formulations giving a rating of at least 4 are considered useful for the final application, and deliver a surprisingly good performance.

TABLE 2
The formulations (in pphp) and characterization
results of Inventive Examples 1 to 4

| | Inventive | Inventive | Inventive | Inventive |
|---|---|---|---|---|
| | Example 1 | Example 2 | Example 3 | Example 4 |
| Polyol 1 | 60.4 | 71.1 | 62.5 | 51.8 |
| Polyol 2 | 32.1 | 21.4 | 21.4 | 32.1 |
| Polyol 3 | 7.5 | 7.5 | 16.1 | 16.1 |
| Polyol 4 | — | — | — | — |
| Water | 3.6 | 3.6 | 3.6 | 3.6 |
| Catalyst | 2.1 | 2.1 | 2.1 | 2.1 |
| DEOA | 0.2 | 0.2 | 0.2 | 0.2 |
| TEOA | 0.5 | 0.5 | 0.5 | 0.5 |
| Silicone | 0.5 | 0.5 | 0.5 | 0.5 |
| Total Polyol | 107.1 | 107.1 | 107.1 | 107.1 |
| Index | 70 | 70 | 70 | 70 |
| Isocyanate | 55.2 | 51.7 | 51.7 | 55.3 |
| Aesthetics | 5 | 5 | 4 | 5 |
| Damping Factor | 0.278 | 0.263 | 0.286 | 0.332 |

TABLE 3
The formulations (by pphp) and characterization results of Comparative Examples (Co. Ex.) 1 to 11

| | Co. Ex. 1 | Co. Ex. 2 | Co. Ex. 3 | Co. Ex. 4 | Co. Ex. 5 | Co. Ex. 6 | Co. Ex. 7 | Co. Ex. 8 | Co. Ex. 9 | Co. Ex. 10 | Co. Ex. 11 |
|---|---|---|---|---|---|---|---|---|---|---|---|
| Polyol 1 | | 92.5 | 81.8 | 57.2 | 83.9 | 73.2 | 67.9 | | | 92.5 | 81.8 |
| Polyol 2 | 32.1 | | 10.7 | 21.4 | | 10.7 | 10.7 | 56.4 | 26 | 7.5 | 18.2 |
| Polyol 3 | 7.5 | 7.5 | 7.5 | 21.4 | 16.1 | 16.1 | 21.4 | 37.0 | 67.4 | | |
| Polyol 4 | 60.4 | | | | | | | | | | |
| Water | 3.6 | 3.6 | 3.6 | 3.6 | 3.6 | 3.6 | 3.6 | 3.6 | 3.6 | 3.6 | 3.6 |
| Catalyst | 2.1 | 2.1 | 2.1 | 2.1 | 2.1 | 2.1 | 2.1 | 2.1 | 2.1 | 2.1 | 2.1 |
| DEOA | 0.2 | 0.2 | 0.2 | 0.2 | 0.2 | 0.2 | 0.2 | 0.2 | 0.2 | 0.2 | 0.2 |
| TEOA | 0.5 | 0.5 | 0.5 | 0.5 | 0.5 | 0.5 | 0.5 | 0.5 | 0.5 | 0.5 | 0.5 |
| Silicone | 0.5 | 0.5 | 0.5 | 0.5 | 0.5 | 0.5 | 0.5 | 0.5 | 0.5 | 0.5 | 0.5 |
| Total Polyol | 107.1 | 107.1 | 107.1 | 107.1 | 107.1 | 107.1 | 107.1 | 107.1 | 107.1 | 107.1 | 107.1 |
| Index | 70 | 70 | 70 | 70 | 70 | 70 | 70 | 70 | 70 | 70 | 70 |
| Isocyanate | 54.8 | 44.5 | 48.1 | 51.7 | 44.6 | 48.2 | 48.2 | 64.8 | 54.2 | 46.9 | 50.5 |
| Aesthetics | 2 | 3 | 4 | 2 | 1 | 2 | 1 | Not | Not | 2 | 3 |
| | | | | | | | | feasible | feasible | | |
| | | | | | | | | (shrinks) | (shrinks) | | |
| Damping | 0.276 | 0.191 | 0.202 | 0.295 | 0.171 | 0.212 | 0.21 | Not | Not | 0.093 | 0.118 |
| Factor | | | | | | | | feasible | feasible | | |
| | | | | | | | | (shrinks) | (shrinks) | | |

As can be seen from the above Table 2 and Table 3, all the inventive examples, which make use of the particularly designed blend of the first, second and third polyether polyol, have successfully achieved a combination of superior defect-free aesthetics performance and good vibration damping performance.

On the contrary, Comparative Examples 2, 5 and 8 to 11, which omitted either one of the first to third polyether polyol, exhibit significant degradation in both the aesthetics and damping performances. The foams of Comparative Examples 2 and 5 were not viscoelastic, with damping factor below 0.20. The Comparative Examples 8 and 9 could not produce a stable viscoelastic foam panel and significant thermal shrinkage was observed. The Comparative Examples 10 and 11 exhibited the worst damping performance and undesirable aesthetics performance.

Comparative Example 1 was performed by replacing the first polyether polyol with identical amount of polyol 4, which is quite similar with the first polyether polyol except that the polyol 4 has a hydroxyl functionality of 3. Nevertheless, such a tiny difference brought about notable degradation in the aesthetics performance.

In the Comparative Examples 3-4 and 6-7, the relative ratios of the first to third polyether polyols were adjusted to a level beyond the numerical scope particularly selected for the present disclosure, and it turned out that such adjustment also resulted in undesired damping and aesthetics performance.

What is claimed is:

1. A polyurethane composition for preparing a viscoelastic polyurethane foam, comprising
(A) at least one isocyanate compound comprising at least two isocyanate groups; and
(B) a polyol blend comprising
(b1) a first polyether polyol which is a poly(C₂-C₆ alkylene oxide)-based polyol end-capped with ethylene oxide moieties and has a OH functionality of 4 or larger,
(b2) a second polyether polyol which is a poly(C₂-C₆ alkylene oxide)-based polyol end-capped with propylene oxide moieties and has a OH functionality of 2 to 6, and
(b3) a third polyether polyol which is a random copolymer of two or more (C₂-C₆)alkylene oxides and has a OH functionality of 2 to 6.

2. The polyurethane composition according to claim 1, wherein
the first polyether polyol has an ethylene oxide content of 14 wt % to 45 wt %, based on the total weight of the first polyol;
the second polyether polyol has a propylene oxide content of up to 100 wt %, based on the total weight of the second polyol;
the third polyether polyol has an ethylene oxide content of from 55 wt % to 90 wt %, based on the total weight of the third polyol; or
any combinations thereof.

3. The polyurethane composition according to claim 1, wherein
the first polyether polyol is a poly(propylene oxide)-based polyol end-capped with ethylene oxide moieties and has a OH functionality of 4 or larger;
the second polyether polyol is a poly(propylene oxide)-based polyol end-capped with propylene oxide moieties and has a OH functionality of 2.5 to 6;
the third polyether polyol is an ethylene oxide-propylene oxide random copolymer having a OH functionality of 2.5 to 6; or
any combinations thereof.

4. The polyurethane composition according to claim 1, wherein
the first polyether polyol is a poly(propylene oxide)-based polyol end-capped with ethylene oxide moieties, and has a OH functionality of 4 or larger and an ethylene oxide content of 14 wt % to 45 wt %, based on the total weight of the first polyol;
the second polyether polyol is a poly(propylene oxide)-based polyol end-capped with propylene oxide moieties, and has a OH functionality of 2.5 to 6 and a propylene oxide content of 5 wt % to 100 wt %, based on the total weight of the second polyol;
the third polyether polyol is an ethylene oxide-propylene oxide random copolymer having a OH functionality of 2.5 to 6 and an ethylene oxide content of from 55 wt % to 90 wt %, based on the total weight of the third polyol; or
any combinations thereof.

5. The polyurethane composition according to claim 1, wherein the polyol blend comprises from 50 to 75 pphp of the first polyether polyol, from 20 to 35 pphp of the second polyether polyol and from 5 to 20 pphp of the third polyether polyol, with the total weight of the polyol blend being taken as 100 pphp.

6. The polyurethane composition according to claim 1, wherein
the first polyether polyol has a molecular weight of 3,000 to 10,000, the second polyether polyol has a molecular weight of 150 to 2,500, and the third polyether polyol has a molecular weight of 1,550 to 10,000.

7. The polyurethane composition according to claim 1, wherein the polyurethane composition further comprises
(C) a blowing agent,
(D) a catalyst,
(E) a surfactant,
(F) a chain extender, or
any combinations thereof.

8. The polyurethane composition according to claim 7, wherein the blowing agent is water, formic acid, or a blend thereof.

9. The polyurethane composition according to claim 7, wherein the chain extender is diethanolamine, triethanolamine, or a blend thereof.

10. The polyurethane composition according to claim 1, wherein the polyurethane composition further comprises at least one additive selected from the group consisting of crosslinker, cocatalyst, fire retardant, reinforcing agent, plasticizer, smoke suppressant, fragrance, adhesion promoters, mold releasing agent, antioxidant, foam stabilizer, tackifier, rheology modifier, UV-absorber, light-stabilizer, filler, colorant, pigment, solvent, diluent, slippery-resistance agent, antistatic agent, preservative, biocide and any combinations thereof.

11. The polyurethane composition according to claim 1, wherein
the isocyanate compound is selected from the group consisting of:
a) C₂-C₁₂ aliphatic isocyanate compound comprising at least two isocyanate groups, C₆-Cis cycloaliphatic isocyanate compound comprising at least two isocyanate groups, C₆-C₁₅ aromatic isocyanate compound comprising at least two isocyanate groups, C₇-C₁₅ araliphatic isocyanate compound comprising at least two isocyanate groups, and any combinations thereof; and
b) an isocyanate prepolymer prepared by reacting one or more isocyanate compound of a) with one or more isocyanate-reactive component selected from the group consisting of C₂-C₁₆ aliphatic polyhydric alcohol comprising at least two hydroxy groups, C₅-C₁₆ cycloaliphatic polyhydric alcohol comprising at least two hydroxy groups, C₆-C₁₆ aromatic polyhydric alcohol comprising at least two hydroxy groups, C₇-Cis araliphatic polyhydric alcohol comprising at least two hydroxy groups, polyester polyol having a molecular weight from 500 to 5,000, polycarbonate polyol having a molecular weight from 200 to 5,000, polyether polyol having a molecular weight from 200 to 8,000, or any combinations thereof, with the proviso that the isocyanate prepolymer comprises at least two free isocyanate groups.

12. The polyurethane composition according to claim 1, wherein the polyurethane composition comprises, based on the total weight of the polyurethane composition, from 25 wt % to 45 wt % of the isocyanate compound, from 50 wt % to 80 wt % of the polyol blend, from 0.1 wt % to 5 wt % of blowing agent, from 0 wt % to 5 wt % of catalyst, from 0 wt % to 5 wt % of surfactant, and from 0 wt % to 5 wt % of chain extender, wherein the total weight percentages add up to 100%.

13. A viscoelastic polyurethane foam product prepared by using the polyurethane composition according to any of claims 1 to 12.
